(19) United States
(12) Patent Application Publication
(10) Pub. No.: US 2023/0316091 A1
(43) Pub. Date: Oct. 5, 2023

(54) FEDERATED LEARNING METHOD AND APPARATUS

(71) Applicant: ELECTRONICS AND TELECOMMUNICATIONS RESEARCH INSTITUTE, Daejeon (KR)

(72) Inventors: Jin-Wuk SEOK, Daejeon (KR); Ji-Young KWAK, Daejeon (KR); Seon-Tae KIM, Daejeon (KR); Hong-Soog KIM, Daejeon (KR); Jae-Bok PARK, Daejeon (KR); Kyung-Hee LEE, Daejeon (KR); Chang-Sik CHO, Daejeon (KR); Hyun-Woo CHO, Daejeon (KR)

(73) Assignee: ELECTRONICS AND TELECOMMUNICATIONS RESEARCH INSTITUTE, Daejeon (KR)

(21) Appl. No.: 18/166,948

(22) Filed: Feb. 9, 2023

(30) Foreign Application Priority Data
Apr. 4, 2022 (KR) 10-2022-0041901
Aug. 3, 2022 (KR) 10-2022-0096506

(51) Int. Cl. G06N 3/098

(52) U.S. Cl. CPC G06N 3/098

(57) ABSTRACT

Disclosed herein are a federated learning method and apparatus. The federated learning method includes receiving a feature vector extracted from a client side and label data corresponding to the feature vector, outputting a feature vector with phase information preserved therein by applying the feature vector as input of a Self-Organizing Feature Map (SOFM), and training a neural network model by applying both the feature vector with the phase information preserved therein and the label data as input of a neural network model.

### CROSS REFERENCE TO RELATED APPLICATIONS

This application claims the benefit of Korean Patent Application Nos. 10-2022-0041901, filed Apr. 4, 2022, and 10-2022-0096506, filed Aug. 3, 2022, which are hereby incorporated by reference in their entireties into this application.

### BACKGROUND OF THE INVENTION

### 1. Technical Field

The present disclosure relates generally to a federated learning method and apparatus for federated learning between a client side and a server side.

### 2. Description of the Related Art

Recently, with the development of artificial intelligence technology, techniques related to classification and semanticization of image data have been applied to multiple fields.

In a medical field which is one of targets to which artificial intelligence technology is to be applied, pieces of data are separately processed in respective hospitals due to the problem of personal security of medical data. However, because the characteristics of diagnostic devices held in respective hospitals are different from each other, the respective hospitals output different diagnosis results.

In order to solve this problem, methodology such as federated learning is presented, but a problem may arise in that all learning networks participating in federated learning need to be identical and in that a time delay occurs and inefficient learning is conducted during a process in which a large amount of data is mutually transferred through communication.

### SUMMARY OF THE INVENTION

Accordingly, the present disclosure has been made keeping in mind the above problems occurring in the prior art, and an object of the present disclosure is to provide a federated learning method and apparatus, which accurately classify the properties of pieces of data using feature vectors extracted from networks having different characteristics.

Another object of the present disclosure is to provide a federated learning method and apparatus, which accurately perform classification of feature vectors by utilizing the distribution of the feature vectors as a phase space.

In accordance with an aspect of the present disclosure to accomplish the above objects, there is provided a federated learning method, including receiving a feature vector extracted from a client side and label data corresponding to the feature vector, outputting a feature vector with phase information preserved therein by applying the feature vector as input of a Self-Organizing Feature Map (SOFM), and training a neural network model by applying both the feature vector with the phase information preserved therein and the label data as input of a neural network model.

The client side may extract the feature vector by applying the input data as input of a partially connected network and classify the feature vector by applying the feature vector as input of a fully connected network.

The federated learning method may further include transmitting a rate of change in a weight of the neural network model to the fully connected network on the client side.

An architecture of the neural network model may correspond to an architecture of the fully connected network on the client side.

The federated learning method may further include varying a learning time based on an average rate of change in a loss function of the neural network model, thus training the Self-Organizing Feature Map (SOFM).

The average rate of change in the loss function may be calculated based on an output vector and the label data.

The Self-Organizing Feature Map (SOFM) may vary a learning time based on an SOFM learning coefficient, thus learning the feature vector.

The neural network model may be a fully connected network.

In accordance with another aspect of the present disclosure to accomplish the above objects, there is provided a federated learning method, including receiving a feature vector string extracted from multiple client sides and label data corresponding to the feature vector string; and preserving phase information of the feature vector string, training a neural network model by applying the feature vector string with the phase information preserved therein as input of the neural network model, and producing an output vector string.

The federated learning method may further include calculating a loss function of a server-side neural network model based on an output value, which is produced by receiving the output vector string as input, and the label data, calculating a gradient based on the loss function, and back-propagating the gradient to the server-side neural network model.

Producing the output vector string may include producing an output vector string with phase information preserved in the feature vector string by applying the feature vector string as input of a self-organizing feature map (SOFM), and performing learning and producing an output vector string by applying the output vector string as input of a fully connected network.

In accordance with a further aspect of the present disclosure to accomplish the above objects, there is provided a federated learning apparatus, including memory configured to store a control program for performing federated learning, and a processor configured to execute the control program stored in the memory, wherein the processor is configured to receive a feature vector extracted from a client side and label data corresponding to the feature vector, output a feature vector with phase information preserved therein by applying the feature vector as input of a Self-Organizing Feature Map (SOFM), and train a neural network model by applying both the feature vector with the phase information preserved therein and the label data as input of a neural network model.

The client side extracts the feature vector by applying the input data as input of a partially connected network, and classifies the feature vector by applying the feature vector as input of a fully connected network.

The processor may be configured to perform control such that a rate of change in a weight of the neural network model is transmitted to the fully connected network on the client side.

An architecture of the neural network model may correspond to an architecture of the fully connected network on the client side.

The processor may be configured to perform control such that a learning time varies based on an average rate of change in a loss function of the neural network model, thus training the Self-Organizing Feature Map (SOFM).

The processor may be configured to perform control such that the average rate of change in the loss function is calculated based on the output vector and the label data.

The Self-Organizing Feature Map (SOFM) may vary a learning time based on an SOFM learning coefficient, thus learning the feature vector.

The neural network model may be a fully connected network.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating a client-side neural network model according to a first embodiment;

FIG. 2 is a block diagram illustrating a federated learning apparatus for performing federated learning with a client side according to a first embodiment;

FIG. 3 is a block diagram illustrating a client-side neural network model according to a second embodiment;

FIG. 4 is a block diagram illustrating a federated learning apparatus for performing federated learning with a client side according to a second embodiment;

FIG. 5 is a block diagram illustrating the detailed configuration of a federated learning apparatus according to a second embodiment;

FIG. 6 is a diagram for explaining an update scheme for SOFM in synchronous learning depending on variation in time and a server-side loss function;

FIG. 7 is a flowchart illustrating a federated learning method performed by a federated learning apparatus according to a first embodiment;

FIG. 8 is a flowchart illustrating a federated learning method performed by a federated learning apparatus according to a second embodiment; and

FIG. 9 is a block diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Embodiments of the present disclosure will now be described in detail with reference to the accompanying drawings. Like numerals refer to like elements throughout, and overlapping descriptions will be omitted.

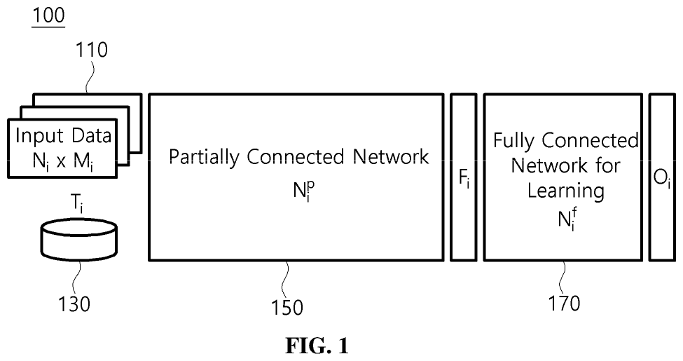

FIG. 1 is a block diagram illustrating a neural network model on a client side according to a first embodiment. Here, the client-side neural network model may be a diagnostic device (a scanner) provided in an individual hospital.

Referring to FIG. 1, a client-side neural network model 100 according to the first embodiment may include a partially connected network 150 and a fully connected network 170.

Here, the partially connected network 150 may refer to a structure in which nodes forming a network are partially connected to each other, and the fully connected network 170 may refer to a structure in which nodes forming the network are fully connected to each other.

Input data 110 applied to the partially connected network 150 may be an input image. The input data 110 may be an Nᵢ×Mᵢ resolution image having three channels Cᵢ=3. Here, Cᵢ may be 1 depending on the properties of the image.

Label data 130 may be data corresponding to the input data 110, and the client-side neural network model 100 may perform supervised learning.

The partially connected network 150 may output a feature vector Fᵢ∈Rⁿ by receiving the input data 110 as input.

The fully connected network 170 may perform a function of classifying feature vectors. Each feature vector may be input to the fully connected network 170, and an output vector Oᵢ∈R^{k} corresponding to the feature vector may be provided from the fully connected network 170.

Here, R⁺ may denote a positive real number set R[0,∞) including 0. R⁺⁺ may denote a positive real number set except for 0. Similarly, for an integer set Z and a rational number set Q, the same inclusion sets (Z⁺, Z⁺⁺⊂Z, Q⁺, Q⁺⁺⊂Q) may be defined.

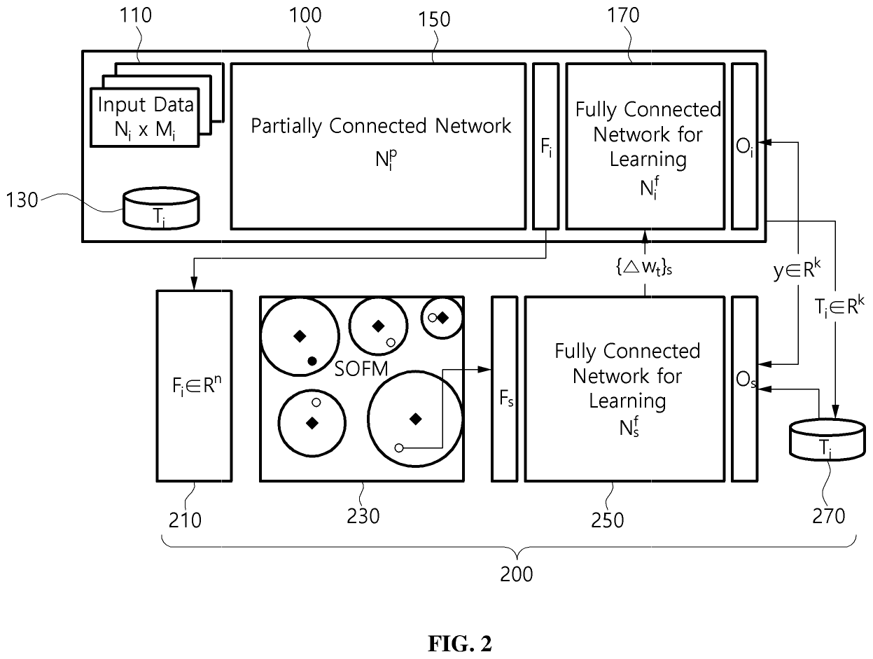

FIG. 2 is a block diagram illustrating a federated learning apparatus for performing federated learning with a client side according to a first embodiment.

As illustrated in FIG. 2, a federated learning apparatus 200 according to the first embodiment may be arranged on a server side. The federated learning apparatus 200 may include a Self-Organizing Feature Map (SOFM) 230 and a server-side neural network model 250.

The SOFM 230 may receive feature vectors extracted from the client-side neural network model 100 as input. The SOFM 230 may perform learning so that respective similar feature vectors in an arbitrary phase space are mapped to each other.

A feature vector Fᵢ∈Rⁿ extracted from an i-th client-side neural network model 100 may output a feature vector F_{S}∈Rⁿ with phase information preserved therein through the SOFM 230.

The server-side neural network model 250 may include a fully connected network. The server-side neural network model 250 may perform learning by receiving, as input, the feature vector with the phase information preserved therein and label data 270, that is, Tᵢ∈R^{k} extracted from the client-side neural network model 100.

The federated learning apparatus 200 may include memory in which the label data 270 can be stored.

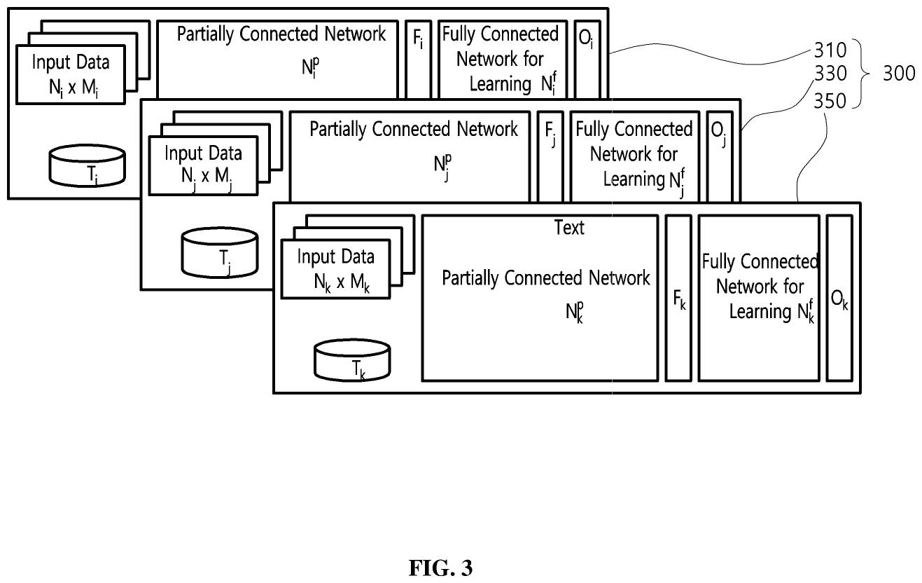

FIG. 3 is a block diagram illustrating a client-side neural network model according to a second embodiment.

As illustrated in FIG. 3, a client-side neural network model 300 according to the second embodiment may include multiple clients. Here, neural network models 310, 330, and 350 installed in the multiple clients, respectively, may have different types of performance. Here, the number of multiple neural network models 310, 330, and 350 is not limited to a specific value.

The multiple neural network models 310, 330, and 350 may be implemented as a high-performance neural network, a middle-performance neural network, and a low-performance neural network, respectively. Here, the multiple neural network models 310, 330, and 350 may be implemented as different networks, but it may be assumed that the dimensions of the feature vectors Fᵢ, Fⱼ, and Fₖ∈Rⁿ and the output vectors Oᵢ, Oⱼ, and Oₖ∈R^{k} are identical to each other.

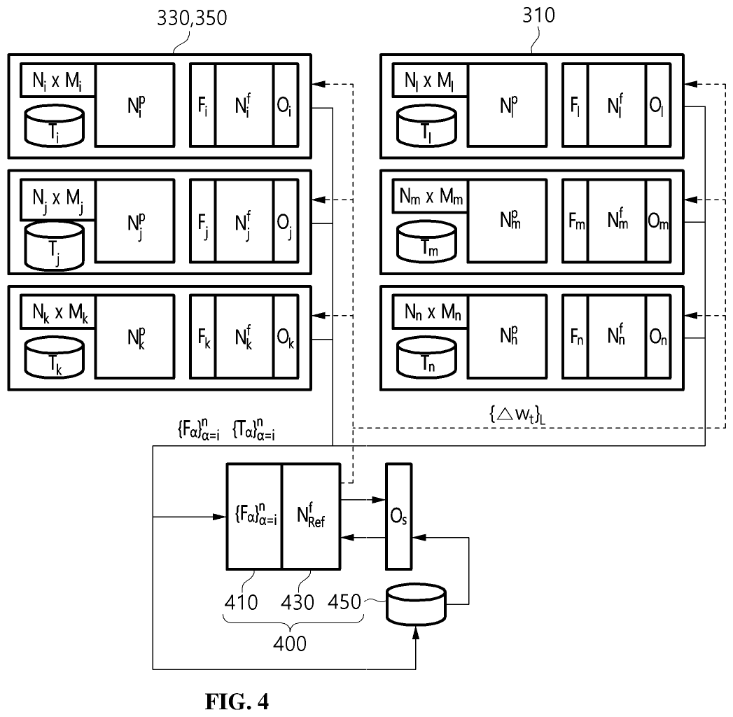

FIG. 4 is a block diagram illustrating a federated learning apparatus for performing federated learning with a client side according to a second embodiment.

As illustrated in FIG. 4, a federated learning apparatus 400 according to the second embodiment may receive feature vectors, output from multiple client-side neural network models 310, 330, and 350, as input, and may produce an output vector.

In the federated learning apparatus 400, a feature vector string {F_{α}}_{α=1}ⁿ 410 and label data {T_{α}}_{α=1}ⁿ 450 corresponding to the index α∈N[1, n] of the client-side neural network model may be input to a server-side neural network model unit 430.

The neural network model unit 430 of the federated learning apparatus may receive the feature vector string as input, and may produce an output vector O_{S}.

The neural network model unit 430 of the federated learning apparatus may calculate a loss function [symbol] (O_{S}, F_{α}) of the federated learning apparatus using the output vector O_{S} and the label data {F_{α}}_{α=1}ⁿ. The neural network model unit 430 may calculate the gradient, the natural gradient, etc. of the loss function, and may back-propagate them to the federated learning apparatus.

In the case of synchronous learning, the rate of change in the weight {wₜ}_{S} of the neural network model unit 430 may be sent to the client-side neural network models 310, 330, and 350, and may be used to update the weight tensor of the client-side fully connected neural network.

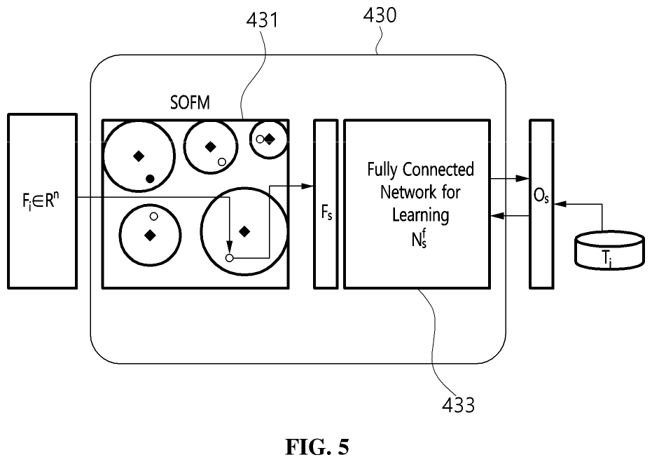

FIG. 5 is a block diagram illustrating the detailed configuration of a federated learning apparatus according to a second embodiment.

As illustrated in FIG. 5, the neural network model unit 430 of the federated learning apparatus according to the second embodiment may include a server-side SOFM 431 and a server-side fully connected network 433.

The server-side SOFM 431 may be configured to preserve the phase of a feature vector, and may apply a feature vector F_{S} to the server-side fully connected network 433.

The server-side fully connected network 433 may receive the feature vector with phase information preserved therein, which is output from the server-side SOFM 431, as input, and may then perform learning.

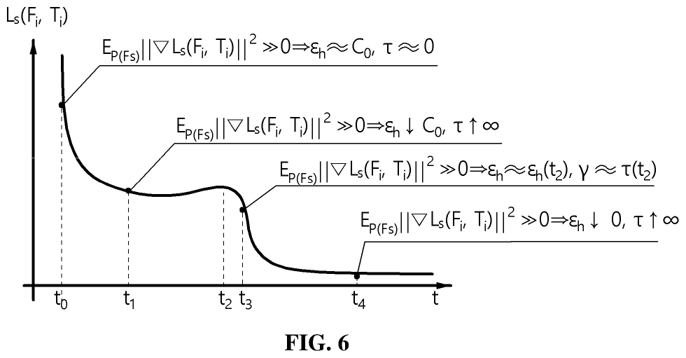

FIG. 6 is a diagram for explaining an update scheme for SOFM in synchronous learning depending on variation in time and a server-side loss function.

In an initial state in which learning is performed by a federated learning apparatus, change in the loss function of a server-side federated learning apparatus is relatively large, and thus the magnitude ∥∇ [symbol] _{S}∥ of the gradient of the loss function of the server-side federated learning apparatus is relatively large, with the result that learning of the SOFM occurs throughout a wide range on SOFM coordinates. Accordingly, the weight vector of the SOFM may be updated to a value relatively close to an input value.

In contrast, when the change in the loss function of the federated learning apparatus is small, the magnitude of the gradient is small, and thus learning of the SOFM occurs throughout a narrow range on SOFM coordinates, and the weight vector of the SOFM may be updated to a value relatively close to an average feature vector value.

In addition, in order merge the label data shown in FIGS. 2, 4, 5, and 6 with a typical federated learning algorithm, the gradient of the loss function generated as a result of inference on each client side, rather than the label data, may be used. In this case, the gradient may be defined as {T_{α}}_{α=1}ⁿ [symbol] {∇ [symbol] _{α}}_{α=1}ⁿ.

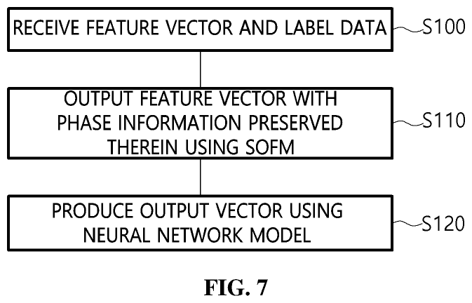

FIG. 7 is a flowchart illustrating a federated learning method performed by the federated learning apparatus according to a first embodiment.

As illustrated in FIG. 7, the federated learning apparatus may receive a feature vector extracted from a client side and label data corresponding to the feature vector at step S100.

The federated learning apparatus may preserve phase information of the feature vector in the feature vector using an SOFM at step S110.

The federated learning apparatus may perform learning by applying the feature vector with the phase information preserved therein as the input of a fully connected network, which is a neural network model. The federated learning apparatus may output an output vector at step S120.

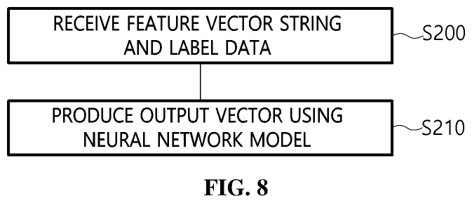

FIG. 8 is a flowchart illustrating a federated learning method performed by the federated learning apparatus according to a second embodiment.

As illustrated in FIG. 8, the federated learning apparatus may receive a feature vector string extracted from multiple client sides and label data corresponding to the feature vector string at step S200.

The federated learning apparatus may perform learning by applying the feature vector string as the input of a neural network model unit, and may produce an output vector string at step S210. Here, the neural network model unit may include an SOFM and a fully connected network.

The federated learning apparatus may calculate the loss function of the neural network model unit based on an output value, which is produced using the output vector string as input, and the label data.

The federated learning apparatus may calculate a gradient based on the loss function, and may back-propagate the gradient to the neural network model unit.

The federated learning apparatus may provide the weight tensor of the neural network model unit to each client-side neural network model unit.

Hereinafter, an asynchronous learning and synchronous learning process will be described in detail.

Assumption for Asynchronous Learning

An asynchronous learning method between a client side and a server-side federated learning apparatus illustrated in FIG. 2 is described as follows.

In FIG. 2, the fully connected network 250 of the federated learning apparatus and the fully connected network 170 of the client-side neural network model may have the same architecture. It may be assumed that the client-side partially connected network 150 primarily completes learning of the input data.

After primary learning is completed, a feature vector Fᵢ∈Rⁿ for arbitrary data and label data Tᵢ∈R^{k} corresponding thereto may be transmitted to the server-side federated learning apparatus 200.

The feature vector received by the server-side federated learning apparatus 200 may be applied as the input of the SOFM 230, and then the SOFM 230 performs self-learning. When learning on the SOFM 230 is sufficiently continued and then an SOFM for phase preservation of the feature vector is created, the fully connected network 250 may learn the output F_{S} of the SOFM 230 together with the label data Tᵢ∈R^{k}.

It may be assumed that system input/output for the following asynchronous learning is made through the client-side neural network model 100 and the federated learning apparatus 200 of FIG. 2.

There may be input data x∈Rⁿ^{ᵢ}^{×m}^{ᵢ}^{×c}^{ᵢ}, and a feature vector corresponding thereto may be defined as Fᵢ∈Rⁿ. For the input data and feature data, an input data set {xₖ}ₖ₌₀ⁿ⁻¹, a feature vector data set {Fᵢ(k)}ₖ₌₀ⁿ⁻¹, and a label data set corresponding to the input data set are present, which may be x∈{xₖ}ₖ₌₀ⁿ⁻¹, Fᵢ∈{Fᵢ(k)}ₖ₌₀ⁿ⁻¹, and Tᵢ∈{Tᵢ(k)}ₖ₌₀ⁿ⁻¹, respectively. Here, k may be the sequence index of data, but, in the present embodiment, the index of the input data is identical to the index of the feature vector, and thus k may be omitted.

One component value 0ᵢ∈R^{k} of the output vector of the client side may be identical to the probability that the feature vector will belong to a specific set C, and may be represented by the following Equation (1):

Oᵢ(Fᵢ)=P(Fᵢ∈C)= [symbol] _{P}_{_{Fi}} sgn(Fᵢ∈C) (1)

In Equation (1), sgn(x) may be a sigmoid function value, and may have a value of 1 when x is true and have a value of 0 when x is false. The specific set C may be designated by binary label data Tᵢ corresponding to Fᵢ. For example, when three-dimensional (3D) label data Tᵢ={1, 0,1} is given, the maximum number of specific sets that can be indicated may be 8. When {0,1,0} is represented by 2 depending on a binary number system, the name of the specific set C may be n(C), and may have a relationship of Equation (2) based on the binary label data.

Tᵢ=n(C),C=n⁻¹(Tᵢ) (2)

In Equation (2), because the fully connected network of the server-side federated learning apparatus and the client-side fully connected network have the same architecture, the probability that the same component in the output vector of the server side will belong to the same specific set may be represented by the following Equation (3) even if the server side undergoes a generalization process passing the SOFM using the same feature data and label data as the client side.

O_{S}(Fᵢ)=P(Fᵢ∈n⁻¹(Tᵢ))= [symbol] _{P}_{_{Fi}} sgn(Fᵢ∈n⁻¹(Tᵢ)) (3)

It may be assumed that the architectures of the client-side fully connected network and the server-side fully connected network are identical to each other.

The weight tensor of the client-side fully connected network may be designated as wᵢ^{f} and the weight tensor of the fully connected neural network of the server-side federated learning apparatus may be designated as w_{S}^{f}. Therefore, spaces formed by the weight tensors of the client-side and server-side fully connected networks are identical to each other (wᵢ, w_{S}∈W), and the output of the fully connected network of the server-side federated learning apparatus may be defined, as represented by the following Equation (4):

O_{S}(Fᵢ)=P(F_{S}∈n⁻¹(Tᵢ)|w)∈R^{k}[0,1] (4)

Based on the above-described assumptions, the loss function of each fully connected network may be defined.

Based on Equation (4), a server-side loss function [symbol] _{S}(Fᵢ, Tᵢ) may be defined as the simplest form, represented by the following Equation (5):

$${ℒ}_{S} ( {F}_{i} , {T}_{i} ) = \frac{1}{2} {\sum }_{k} {( {O}_{S} ( {F}_{i} ) ( k ) - {T}_{i} ( k ) )}^{2} \qquad ( 5 )$$

Because the weight tensor of the server-side fully connected network may be regarded as a random variable, the output of the fully connected network may also be regarded as a random variable, as shown in Equation (4). Therefore, the loss function of the server-side fully connected network may be defined as the covariance of the output of the fully connected network, as represented by the following Equation (6):

$$\begin{matrix}{L}_{S} ( {F}_{i} , {T}_{i} ) = {𝔼}_{{x}_{k}} {‖ {O}_{S} ( {F}_{i} ) - {T}_{i} ‖}^{2} \\ = {\int }_{Ω} {( {O}_{S} ( {F}_{i} ) - {T}_{i} )}^{T} P ( {F}_{i} \vert {x}_{k} ) ( {O}_{S} ( {F}_{i} ) - {T}_{i} ) dx \\ \approx \frac{1}{2 n} {\sum }_{k = 1}^{n - 1} {( {O}_{S} ( {F}_{i} ) ( k ) - {T}_{i} ( k ) )}^{2}\end{matrix} \qquad ( 6 )$$

The last approximate value in Equation (6) may be an empirical expectation value or a simple numerical average value.

Asynchronous Learning

An asynchronous learning method performed by a federated learning apparatus according to an embodiment may be a method for securing both the independency of a client side and the generality of a server side in such a way that the server side learns only the result of self-organizing of a feature vector obtained as a result of learning on the client side while maintaining the result of learning on the client side.

In a pure asynchronous learning method, only a feature vector set {Fᵢ(k)}ₖ₌₀ⁿ⁻¹ and label data {Tᵢ(k)}ₖ₌₀ⁿ⁻¹ corresponding to the feature vector set are transmitted from the client side to the server side, and each feature vector and the label data are stored in the memory on the server side, and thus data transmission is not performed any further when all of the feature vector set is transmitted.

Therefore, the pure asynchronous learning method may be used in fields requiring normal learning results while maintaining the independency of learning on the client side. When the results of classification on the client side and normal results of inference on the server side are different from each other, the probabilities of classification accuracy may be compared with each other, and thus classification results may be inferred.

For example, assuming that the weight of the result of inference on the client side is 0.4 and the result of inference on the server side is 0.6, it may be determined that, if the probability Oᵢ(Fᵢ)(k) of inference on the client side for the input data xₖ is 0.6 and the result of inference on the server side O_{S}(Fᵢ)(k) is 0.4, 0.4×0.6+0.6×0.4=0.48 is obtained, and the result of inference is below 0.5, and thus the result of classification is rejected.

In other words, the probability of classification of a generalization feature vector having passed the SOFM may be the value of each component in the server-side output vector. Therefore, a user may determine the result of classification of data received from any client side by comparing the result of classification with the result of independent learning on the client side and the result of normal learning on the server side. Apparently, such a comparison and determination process may be programmed and performed by a computing device.

Assumption for Synchronous Learning

A synchronous learning method between a client side and a server-side federated learning apparatus, illustrated in FIG. 2, is described as follows.

First, before pure synchronous learning is defined, the following assumption may be made.

It may be assumed that a client-side fully connected neural network and the fully connected network of a server-side federated learning apparatus has been initialized.

Because the corresponding learning method is synchronous learning, input data xᵢ∈Rⁿ^{ᵢ}^{×m}^{ᵢ}^{×c}^{ᵢ} may be present, and a feature vector corresponding to the input data may be defined as F_{i,t}∈Rⁿ. Further, label data corresponding to the feature vector may be defined as T_{i,t}∈R^{k}. Here, t∈Z⁺ may be the sequence index of input data that is applied to the client side, and may be considered to be identical to a parameter designated as k in asynchronous learning. Although t∈Z⁺ may be regarded as a parameter for time, the sequence index k may be k [symbol] mod(t,n), which is the remainder when t is divided by n in the case where the supremum of the sequence index is n.

Unlike in the case of asynchronous learning, in synchronous learning, an index for each piece of data and iterative learning needs to be present by adding a parameter for time to the weight tensor of the fully connected network. Therefore, the weight tensor of the client-side fully connected network may be represented by wₜⁱ, and the weight tensor of the server-side fully connected network may be represented by wₜ^{S}.

Similar to asynchronous learning, assuming that the architectures of fully connected networks are identical to each other even in synchronous learning, the weights of the fully connected networks may have a relationship of ∀t>0, wₜⁱ, wₜ^{S}∈W with the weight tensor space W of the fully connected networks.

When label data is not used, T_{i,t}∈R^{k} may be regarded as the gradient of a loss function calculated on the last layer of the server-side fully connected network. Assuming that the dimension of the output layer is k and the dimension of layer l just previous to the output layer is n, T_{i,t} may be represented by T_{i,t} [symbol] wₜⁱ [symbol] _{i,t}∈R^{k×n}.

Learning Method in SOFM for Synchronous Learning

First, a continuous time parameter τ∈R⁺ may be defined, and a discrete time parameter corresponding to the continuous time parameter may be defined as t_{q}∈Z⁺. t_{q} may be a value obtained by quantizing τ, and may be defined as t_{q}(τ) [symbol] ┌τ┐.

The continuous time parameter may be defined as being updated, as shown in Equation (7).

τ←τsech(λ̅·∥ [symbol] _{P(F}_{_{S}}₎∇ [symbol] _{S}(F_{i,t},T_{i,t})∥²) (7)

In Equation (7), sech(x) may be a hyperbolic secant function, and x̅∈R(0,∞) may be a proportional constant for input x. Equation (7) may be modified into and used by Equation (8):

τ←τsech(λ̅·∥ [symbol] _{P(F}_{_{S}}₎∇ [symbol] _{S}(F_{i,t},T_{i,t})∥²)

τ←τsech(λ̅·Tr(F_{P(F}_{_{S}}₎)) (8)

In Equation (8), F_{P(F}_{_{S}}₎ may be a Fisher information matrix for the loss function [symbol] _{S}(Fᵢ, Tᵢ), and Tr may be the trace of the matrix. In Equation (7), the average gradient of the loss function may be obtained using a simple numerical average, but, in the embodiment, all gradient values for all time indices are stored, and thus efficiency is deteriorated. When the average gradient is placed as gₜ [symbol] [symbol] _{P(F}_{_{S}}₎∇ [symbol] _{S}(F_{i,t}, T_{i,t}) instead of storing all gradient values, a weight average 71 may be obtained, as represented by the following Equation (9):

gₜ₊₁=gₜ+η(∇ [symbol] _{S}(F_{i,t},T_{i,t})−gₜ),∴η∈R(0,1) (9)

In Equation (9), when the value of 71 is close to 1, the value of gₜ varies sensitively to the value of [symbol] _{S}(Fᵢ, Tᵢ), whereas when the value of η is close to 0, the value of gₜ varies insensitively to change in [symbol] _{S}(Fᵢ, Tᵢ). Typically, the value of η may be set to 0.125, but it may vary with the properties of the input data.

The SOFM may have the coordinates r∈R^{m} of the SOFM so as to preserve the phase characteristics of the feature vector. In the present disclosure, the SOFM may be assumed to be a two-dimensional (2D) self-organizing feature map, a coordinate space of the SOFM may be regarded as S, and a relationship of r∈S⊂R² may be defined. Generally, when the 2D self-organizing feature map (SOFM) is used, the coordinate space of the SOFM may be S, and S may be defined as S [symbol] N^{r×s} if r∈N points are present in a lateral direction and s c N points are present in a longitudinal direction.

The weight vector on the coordinates r c S in the SOFM may be assumed to be w̅ₜ^{r}∈Rⁿ.

As shown in Equation (10), the SOFM may be trained with the feature vector F_{i,t}, received as input, using the discrete time parameter t_{q} corresponding to a continuous time function defined in Equations (8) and (9).

$$\tilde{r} = {arg}_{γ} {min}_{r ∈ S} ‖ {F}_{i , t} - {\overline{w}}_{t}^{r} ‖ \qquad ( 10 )$$

$${\overline{w}}_{t + 1}^{r} = {\overline{w}}_{c}^{r} + {ε}_{h} ( {t}_{q} ( τ ) ) \cdot h ( \tilde{r} , r , {t}_{q} ( τ ) ) \cdot ( {F}_{i , t} - {\overline{w}}_{t}^{r} )$$

In Equation (10), εh(x), which is the learning coefficient of the SOFM, may be a monolithically decreasing function over time, and may satisfy the requirement of Equation (11).

∀x∈Z⁺,εₕ(x)∈R,εₕ(x)↓0, and Σₓ₌₀^{∞}εₕ(x)=∞,Σₓ₌₀^{∞}εₕ²(x)<∞ (11)

One format of the learning coefficient of the SOFM satisfying Equation (11) is represented by the following Equation (12):

$${{ε}_{h} ( {t}_{q} ( τ ) ) = \frac{{C}_{0}}{{α}_{ε} \cdot {t}_{q} ( τ ) + {β}_{ε}} \vert}_{{C}_{0} = 0.95 , {α}_{ε} = 1 , {β}_{ε} = 1} \qquad ( 12 )$$

In Equation (12), Cₒ, α_{ε}, and β_{ε}∈R⁺⁺ may be learning coefficient parameters, and may be experimentally determined. It is better to select a value, which is less than 1, but is closer to 1, as Cₒ. Suitable values may be selected as β_{ε}, and B_{ε} depending on the number of times that learning is performed and the amount of learning data.

In Equation (10), h(\tilde{r},r,t_{q}(τ) may be a neighborhood function, and may be represented by Equation (13):

h(\tilde{r},r,t_{q}(τ))=exp(−γ·(τ+∂)·λr−\tilde{r}∥)|_{γ=0.1,∂=10}_{^{−6}} (13)

In Equation (13), γ and Q∈R⁺⁺ may be parameters for determining the format of the neighborhood function, and may be experimentally determined. Here, small values falling within the range of numbers greater than 1 need to be used as γ and ∂, and the smallest value in the range may be used as Q.

Referring to FIG. 6, when the average [symbol] _{P(F}_{_{S}}₎∥V [symbol] _{S}(Fᵢ, Tᵢ)∥² of the magnitudes of the gradient of the server-side loss function is large, variation in τ decreases according to Equations (7) and (8). Therefore, the magnitude of the learning coefficient becomes similar to that of the learning coefficient in a previous time according to Equation (11). As a result, in the initial stage of learning, the weight vector may be updated similar to the input feature vector, and in the middle stage of learning, the weight vector may be updated in proportion to the magnitude of the previous learning coefficient. Further, in the initial stage of learning, the magnitude of the neighborhood function may be defined within a wide range, and in the middle stage of learning, the weight vector may be updated to a value closer to the magnitude of the previous neighborhood function.

On the other hand, when the average [symbol] _{P(FP}_{_{S}}₎∥∇ [symbol] _{S}(Fᵢ, Tᵢ)∥² of the magnitudes of the gradient of the server-side loss function is small, variation in τ increases, and thus the learning coefficient starts to relatively decrease, and the magnitude of the neighborhood function also decreases. As a result, the weight vector of the individual coordinates of the SOFM may converge to a partial average value formed by the input feature vector.

Synchronous Learning

A synchronous learning method may be a method for initializing the weight tensors wᵢ^{t}, wₜ^{S}∈W of client-side and server-side fully connected networks to the same value, updating a SOFM weight w̅ₜ^{r}∈Rⁿ by applying a client-side feature vector F_{i,t}∈Rⁿ at time index t to a server-side SOFM, updating the weight tensor wₜ^{S}∈W of the server-side fully connected network using label data T_{i,t}∈R^{k} corresponding to the client-side feature vector F_{i,t} by utilizing the updated result value {w_{t+1,α}^{r}}_{α=0}ⁿ⁻¹≡{F_{s,t,α}}_{α=0}ⁿ⁻¹∈Rⁿ as the server-side feature vector, and thereafter updating the weight tensor Wₜⁱ∈W of the client-side fully connected network by sending only the updated value Δwₜ^{S} of the weight tensor to the client side.

Here, the weight tensor of the client-side partially connected network may be updated through a back-propagation algorithm based on an updated weight value in the first layer of the fully connected network.

Synchronous learning is aimed at maintaining the characteristics of a client-side network and a server-side network at similar characteristics, thus allowing both the client side and the server side to have similar distributions for feature vectors and inference results.

When the server side and the client side have different inference engines, as illustrated in FIG. 4, but the architectures of fully connected networks thereof are identical to each other, the feature vector {F_{α,t}}_{α=0}ⁿ⁻¹∈Rⁿ of each client side and label data {Tα,t}_{α=0}ⁿ⁻¹∈R^{k} corresponding thereto at time index t are received, after which the weight of the SOFM may be updated, and the weight tensor wₜ^{S}∈W may be updated using the label data {T_{i,t}}ᵢ₌₀ⁿ⁻¹∈R^{k} based on the updated result value.

Furthermore, such synchronous learning is a scheme for copying the updated value Δwₜ^{S} of the weight tensor a number of times identical to the number of client sides, and then sending the copied result, as {Δwₜ}_{L}, to each client side {w̅_{t+1,α}}_{α=0}ⁿ⁻¹∈{F_{s,t,α}}_{α=0}ⁿ⁻¹∈Rⁿ.

Conventional federated learning is a scheme for receiving all updated weight values of respective client sides and calculating the numerical average of the updated weight values, thus updating both the server side and the client sides. On the other hand, the present disclosure is a scheme for sending the updated value of the weight tensor of the server-side fully connected network to each client side without change, without calculating a numerical average on the server side due to the presence of the SOFM.

By means of this scheme, the weight tensor of a feature vector-based fully connected network generalized through an SOFM on the server side is formed on each client side, all clients on the client sides may converge to similar inference results based on the unification of fully-connected networks even if partially connected networks are different from each other.

Client-Side Partial Synchronous/Synchronous Learning

Partial synchronous/synchronous learning on each client side is a method for, when generalization performance on a server side is deteriorated due to the influence of some systems, or the inference tendency of some systems is greatly different from that of the entire system in the state in which learning of the entire system is completed, correcting the corresponding system to have classification characteristics which are as similar to classification characteristics of a server-side system as possible.

First, a server-side generalization inference system is established through asynchronous learning, and synchronous learning may be performed on a client having higher local inference characteristics and then having a greatly different inference tendency, compared to server-side inference capability, through a test conducted for each system.

In this case, in order to prevent generalization capability on the server side from being deteriorated, the weight tensor value of the client-side fully connected network may be initialized to the weight tensor value of the server-side fully connected network, and then the client side may perform learning. In this case, two types of learning may be conducted.

First, there is an asynchronous learning method in which a server side does not conduct learning, and only a client-side conducts learning, and which is intended to correct only the characteristics on the client side to be similar to those on the server side while maintaining generalization capability on the server side without change.

Second, there is a synchronous learning method in which the server-side sets learning parameters of an SOFM and learning parameters of a fully connected network to small values so as to maintain generalization capability, whereas the learning parameters on a client side may be set to values identical to previous values. By means of this, the server side partially incorporates correction results into a problematic client side, and the client side has unique learning results on the client side based on generalization capability on the server side.

Synchronous Learning in which Label Data is not Used

An embodiment may conduct synchronous learning using the gradient of a loss function instead of label data in order to further strengthen information security. Here, assuming that the gradient of a weight tensor wₜ^{i,l} between an output layer having k dimensions and a just previous layer l having m dimensions is ∇wₜ^{i,l} [symbol] _{i,t}∈R^{n×k} for the loss function on each client side instead of the label data, {T_{α,t}}_{α=0}ⁿ⁻¹ ,148 {∇wₜ^{i,l} [symbol] _{i,t}∈R^{n×k}}^{α=0}ⁿ⁻¹, instead of the label data, may be set. In this case, learning and update of the SOFM may be performed, as defined in Equations (7) and (13), and the update of the fully connected network may be set using the simple numerical average of gradient tensor strings of the transmitted client-side loss function and the gradient of the weight tensor wₜ^{S,l} between the output layer of the server-side loss function and the just previous layer l at time t. The gradient is represented by the following Equation (14).

$${∇}_{{w}_{t}^{S , l}} {ℒ}_{S , t} ≡ \frac{1}{n} {\sum }_{α = 0}^{n - 1} {∇}_{{w}_{t}^{i , l}} {ℒ}_{i , t} \qquad ( 14 )$$

Learning may be performed using the gradient defined in Equation (14) as a basic gradient for updating the weight tensor in the server-side fully connected network.

The federated learning apparatus according to an embodiment may be implemented in a computer system such as a computer-readable storage medium.

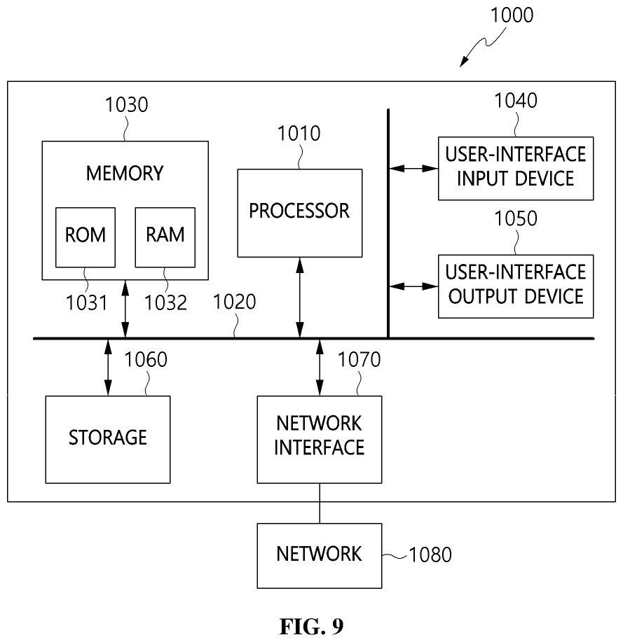

FIG. 9 is a block diagram illustrating the configuration of a computer system according to an embodiment.

Referring to FIG. 9, a computer system 1000 according to an embodiment may include one or more processors 1010, memory 1030, a user interface input device 1040, a user interface output device 1050, and storage 1060, which communicate with each other through a bus 1020. The computer system 1000 may further include a network interface 1070 connected to a network 1080.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the federated learning apparatus.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an application-specific integrated circuit (ASIC), a field-programmable gate array (FPGA), etc., without being limited thereto.

The memory 1030 may store various types of data for the overall operation such as a control program for performing a federated learning method according to an embodiment. In detail, the memory 1030 may store multiple applications executed by the federated learning apparatus, and data and instructions for the operation of the federated learning apparatus.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

The present disclosure may perform learning by preserving the phases of feature vectors collected from client sides, thus improving classification performance.

Further, the present disclosure may perform federated learning through multiple clients and a server-side federated learning apparatus, thus improving a operation speed for data classification.

Furthermore, the present disclosure may use only a feature vector on a client side, thus avoiding differences in data processing while preserving the characteristics of the client side.

Furthermore, the present disclosure may strengthen security by utilizing only a minimum number of feature vectors and minimum output data.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A federated learning method, comprising:
receiving a feature vector extracted from a client side and label data corresponding to the feature vector;
outputting a feature vector with phase information preserved therein by applying the feature vector as input of a Self-Organizing Feature Map (SOFM); and
training a neural network model by applying both the feature vector with the phase information preserved therein and the label data as input of a neural network model.

2. The federated learning method of claim 1, wherein the client side extracts the feature vector by applying the input data as input of a partially connected network, and classifies the feature vector by applying the feature vector as input of a fully connected network.

3. The federated learning method of claim 2, further comprising:
transmitting a rate of change in a weight of the neural network model to the fully connected network on the client side.

4. The federated learning method of claim 2, wherein an architecture of the neural network model corresponds to an architecture of the fully connected network on the client side.

5. The federated learning method of claim 1, further comprising:
varying a learning time based on an average rate of change in a loss function of the neural network model, thus training the Self-Organizing Feature Map (SOFM).

6. The federated learning method of claim 5, wherein the average rate of change in the loss function is calculated based on an output vector and the label data.

7. The federated learning method of claim 1, wherein the Self-Organizing Feature Map (SOFM) varies a learning time based on an SOFM learning coefficient, thus learning the feature vector.

8. The federated learning method of claim 1, wherein the neural network model is a fully connected network.

9. A federated learning method, comprising:
receiving a feature vector string extracted from multiple client sides and label data corresponding to the feature vector string; and
preserving phase information of the feature vector string, training a neural network model by applying the feature vector string with the phase information preserved therein as input of the neural network model, and producing an output vector string.

10. The federated learning method of claim 9, further comprising:
calculating a loss function of a server-side neural network model based on an output value, which is produced by receiving the output vector string as input, and the label data, calculating a gradient based on the loss function, and back-propagating the gradient to the server-side neural network model.

11. The federated learning method of claim 9, wherein producing the output vector string comprises:
producing an output vector string with phase information preserved in the feature vector string by applying the feature vector string as input of a self-organizing feature map (SOFM); and
performing learning and producing an output vector string by applying the output vector string as input of a fully connected network.

12. A federated learning apparatus, comprising:
a memory configured to store a control program for performing federated learning; and
a processor configured to execute the control program stored in the memory,
wherein the processor is configured to receive a feature vector extracted from a client side and label data corresponding to the feature vector, output a feature vector with phase information preserved therein by applying the feature vector as input of a Self-Organizing Feature Map (SOFM), and train a neural network model by applying both the feature vector with the phase information preserved therein and the label data as input of a neural network model.

13. The federated learning apparatus of claim 12, wherein the client side extracts the feature vector by applying the input data as input of a partially connected network, and classifies the feature vector by applying the feature vector as input of a fully connected network.

14. The federated learning apparatus of claim 13, wherein the processor is configured to perform control such that a rate of change in a weight of the neural network model is transmitted to the fully connected network on the client side.

15. The federated learning apparatus of claim 13, wherein an architecture of the neural network model corresponds to an architecture of the fully connected network on the client side.

16. The federated learning apparatus of claim 12, wherein the processor is configured to perform control such that a learning time varies based on an average rate of change in a loss function of the neural network model, thus training the Self-Organizing Feature Map (SOFM).

17. The federated learning apparatus of claim 16, wherein the processor is configured to perform control such that the average rate of change in the loss function is calculated based on the output vector and the label data.

18. The federated learning apparatus of claim 12, wherein the Self-Organizing Feature Map (SOFM) varies a learning time based on an SOFM learning coefficient, thus learning the feature vector.

19. The federated learning apparatus of claim 12, wherein the neural network model is a fully connected network.
